(19) United States
(12) Patent Application Publication
(10) Pub. No.: US 2015/0227677 A1
(43) Pub. Date: Aug. 13, 2015

(54) Gas Turbine Engine With First Turbine Vane Clocking

(71) Applicant: UNITED TECHNOLOGIES CORPORATION, Hartford, CT (US)

(72) Inventors: Om P. Sharma, South Windsor, CT (US); Michael F. Blair, Manchester, CT (US)

(21) Appl. No.: 14/428,021

(22) PCT Filed: Feb. 17, 2013
(86) PCT No.: PCT/US2013/026552

§ 371 Date: Mar. 13, 2015

Related U.S. Application Data
(60) Provisional application No. 61/708,348, filed on Oct. 1, 2012.

(51) Int. Cl. G06F 17/50; F02C 3/10; F01D 9/02

(52) U.S. Cl. CPC G06F 17/5086; F01D 9/023; F02C 3/10

(57) ABSTRACT

A gas turbine engine design process includes the steps of determining the location of a hot streak downstream of a combustor nozzle, and determining whether it would be most beneficial to have the hot streak initially impact a pressure side of a first static turbine vane or whether it would be more beneficial to have it impact a suction side. A location is designed for the first static turbine vane such that the hot streak will impact the more beneficial side of the first static turbine vane.

### CROSS-REFERENCE TO RELATED APPLICATION

This application claims priority to U.S. Provisional Application Ser. No. 61/708,348 which was filed Oct. 1, 2012.

### BACKGROUND OF THE INVENTION

This application relates to a location for a first static vane in a turbine section of a gas turbine engine to achieve optimum interaction with hot streaks in the flow of products of combustion.

Gas turbine engines are known and, typically, include a fan delivering air into a bypass duct and into a compressor section. The air downstream of the compressor is passed into a combustion section where it is mixed with fuel and ignited. Products of this combustion pass downstream through a turbine section. Generally, immediately downstream of combustor nozzles, a row of static turbine blades serve to direct the flow of the products of combustion as they approach a first rotor stage of the turbine section.

Typically, there is another row of static vanes downstream of the first rotor stage of the turbine section. There may be more stages of the turbine rotor and additional static vane stages.

The products of combustion exit a plurality of combustor nozzles and pass across the first row of static vanes. Since the nozzles are circumferentially spaced, the temperature as it approaches the first row of static vanes is not uniform across the circumference of the engine. Rather, there are hot streaks generally circumferentially aligned with a location of a combustor nozzle.

It has been proposed to “clock” or position one of the static turbine vanes directly in front of each of the turbine nozzles. Typically, there are more vanes than nozzles and there may be a multiple of two in one example.

By clocking the static turbine vane to be aligned with the output of the combustor nozzle, the vane is thought to be more likely to begin to achieve a more uniform temperature distribution across the entire circumferential flow area of the products of combustion.

However, the results of clocking to date have been somewhat limited.

### SUMMARY OF THE INVENTION

In a featured embodiment, a gas turbine engine design process includes the steps of determining the location of a hot streak downstream of a combustor nozzle, and determining whether it would be most beneficial to have the hot streak initially impact a pressure side of a first static turbine vane or whether it would be more beneficial to have it impact a suction side. A location is determined for the first static turbine vane such that the hot streak will impact the more beneficial side of the first static turbine vane.

In another embodiment according to the previous embodiment, the location of the hot streak is determined by computer modeling.

In another embodiment according to any of the previous embodiments, the computer modeling relies on computational fluid dynamics.

In another embodiment according to any of the previous embodiments, when it is determined that it would be more beneficial to have the benefits of the positioning of the first static turbine vane manifest themselves at a more uniform temperature field when the products of combustion will reach a second static turbine vane, then the first static turbine vane is positioned such that the hot streak impacts the pressure side. When it is determined that it would be more beneficial to have the benefits of a more uniform temperature manifest themselves at a first stage rotor, then the first static turbine vane is positioned such that the hot streak will impact the suction side.

In another embodiment according to any of the previous embodiments, the suction side is selected to impact the hot streak when the first stage rotor is a single stage rotor.

In another featured embodiment, a gas turbine engine has a combustor with a plurality of combustor nozzles. A first row of static turbine vanes is positioned downstream of the combustor nozzles and a first turbine rotor stage is positioned downstream of the first row of the static turbine vanes. The static turbine vanes include a pressure side and a suction side. The combustor nozzles create a hot streak within a flow of products of combustion approaching the first row of static turbine vanes with some of the first row of static turbine vanes positioned such that the hot streak will impact one of the suction side and pressure side.

In another embodiment according to the previous embodiment, the location of the hot streak is determined by computer modeling.

In another embodiment according to any of the previous embodiments, the computer modeling relies on computational fluid dynamics.

In another embodiment according to any of the previous embodiments, the hot streak impacts the suction side and the first turbine rotor stage is a single stage rotor.

These and other features may be best understood from the following drawings and specification.

### BRIEF DESCRIPTION OF THE DRAWINGS

FIG. 1 schematically shows a gas turbine engine.

FIG. 2 schematically shows a portion of the FIG. 1 gas turbine engine.

FIG. 3A shows a first design location.

FIG. 3B shows a second design location.

### DETAILED DESCRIPTION

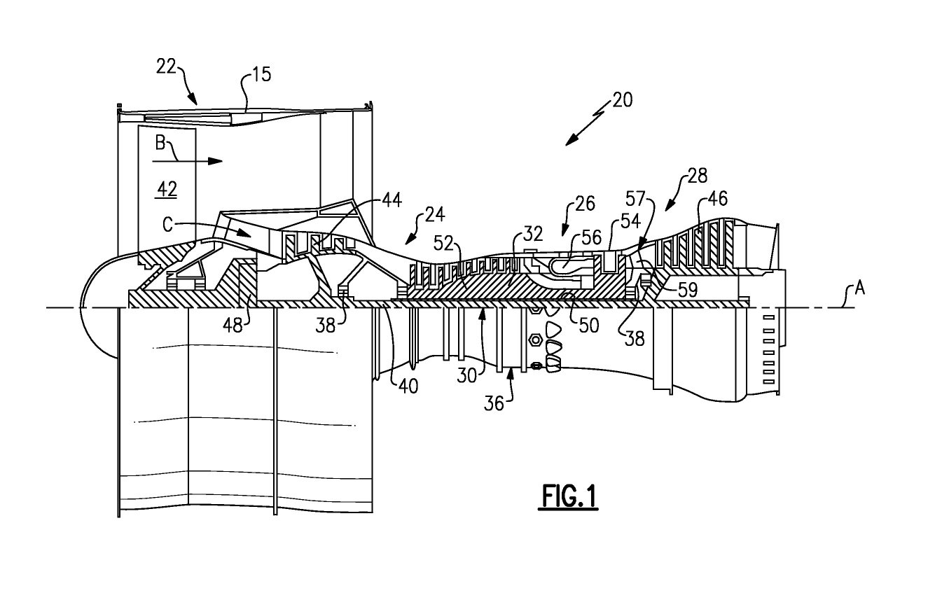

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second.insert

FIG. 2 shows a plurality of combustor nozzles 80 and 82. FIG. 2 is, of course, a flat view, however, it should be understood that in the engine 20, all of the illustrated elements would curve about centerline A.

Products of combustion leave the nozzles 80 and 82 and approach a first row of static vanes 84. The row of static vanes 84 include a plurality of vanes 86, which are “clocked” to be aligned with one of the nozzles 80 and 82 and other vanes 88 which are spaced between nozzles 80 or 82. The vanes 86 have cavities 87 shown schematically, and the vane 88 has a cavity 89 shown schematically. A flow of air in passage 100 is schematically shown communicating with the cavities 87 and 89, and serves to cool the vanes 86 and 88. It should be understood that the vanes 86 will “see” higher temperatures than will the vanes 88 and, thus, they may be designed to receive higher volumes of cooling air.

Downstream of the row of static vanes 84 is a first stage turbine rotor 90. This first stage turbine rotor 90 includes a plurality of blades 92.

Downstream of the first stage turbine rotor 90 is another row of vanes 93. The row of vanes 93 includes a plurality of static turbine vanes 94, each having cavities 104 provided with a flow of cooling air in a passage 102, also shown schematically. By the time the products of combustion reach row 93, they will be cooler than when reaching row 84. As such, less cooling air should be necessary at the row 93.

In the prior art, the vanes 86 have been “clocked” to merely be circumferentially centered in front of a combustor nozzle 80 or 82.

This application discloses a method for designing a location for the vanes 86 which is more preferable than simply being centered.

Modern engine technology allows modeling that can predict the location of “hot streaks” in the flow of the products of combustion. As an example, computational fluid dynamics may be used to achieve the modeling. Analytical studies already conducted for a variety of turbine configurations indicate that computational fluid dynamics can reveal optimum-clocking-benefit circumferential locations of the fuel nozzles relative to the first stage vanes. These hot streaks may not be directly centered on a circumferential center of the nozzle 82 or 80.

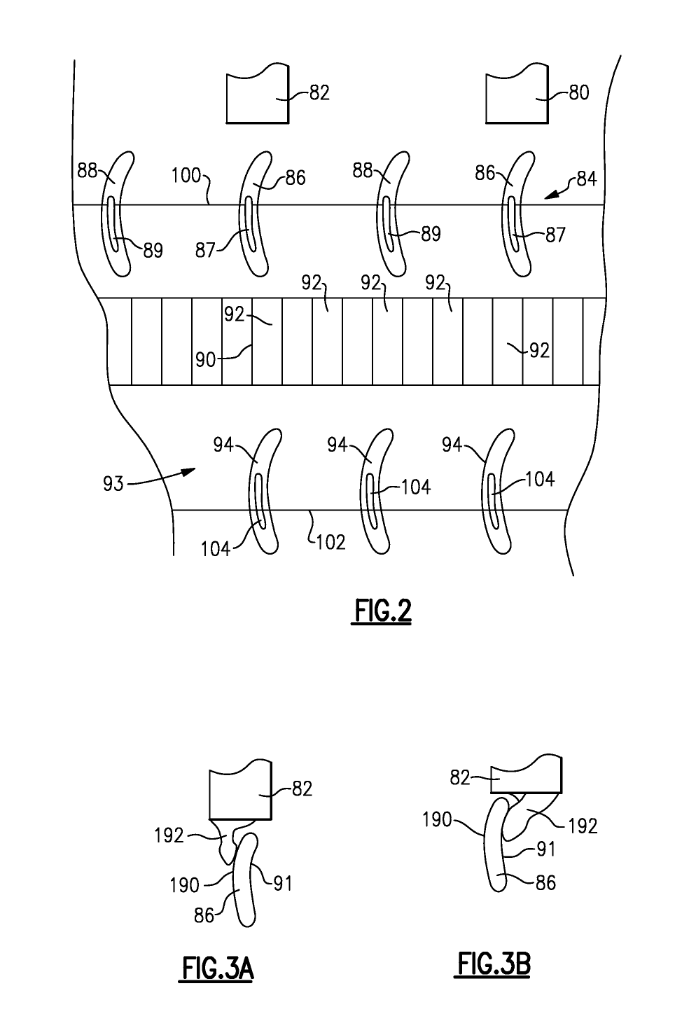

Once the location of the hot streaks is known, and once the overall engine design is known, a worker of ordinary skill in this art will be able to recognize that the flow of the products of combustion and, in particular, the location of where the hot streak impacts upon the static turbine vanes 86 can provide different benefits. As an example, as shown in FIG. 3A, a vane 86 is positioned such that the “hot streak” 192 impacts a suction wall 190 rather than a pressure wall 91.

Alternatively, as positioned in FIG. 3B, that same hot streak 192 will impact the pressure wall 91.

Applicant has recognized that when the hot streak 192 is aimed at the pressure side 191, the benefits of the clocking will manifest themselves as a more uniform temperature field entering the second vane row 93.

On the other hand, when the hot streak 192 is impacted upon the suction wall 190, the benefit will be a more uniform inlet field to the first stage rotor 90.

In many engine applications, it may be more desirable to have the more uniform temperature field entering the second vane stage 93. However, in other applications it may be more beneficial to have the benefits of the more uniform field recognized at the first turbine stage 90. One particular time when achieving the benefit at the first turbine stage 90 may well be true is when the high pressure turbine is a single stage turbine.

However, a worker of ordinary skill in the art would recognize that a countless number of variables and computations are involved in the design of the gas turbine engine, and a worker of ordinary skill in the art would recognize when the benefits would be best achieved at the second static turbine vane row 93 as opposed to the first stage rotor 90.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine design process comprising the steps of:
determining the location of a hot streak downstream of a combustor nozzle;
determining whether it would be most beneficial to have the hot streak initially impact a pressure side of a first static turbine vane or whether it would be more beneficial to have it impact a suction side; and
designing a location for the first static turbine vane such that the hot streak will impact the more beneficial side of the first static turbine vane.

2. The gas turbine engine design process as set forth in claim 1, wherein the location of the hot streak is determined by computer modeling.

3. The gas turbine engine design process as set forth in claim 2, wherein the computer modeling relies on computational fluid dynamics.

4. The gas turbine engine design process as set forth in claim 1, wherein when it is determined that it would be more beneficial to have the benefits of the positioning of the first static turbine vane manifest themselves at a more uniform temperature field when the products of combustion will reach a second static turbine vane, then the first static turbine vane is positioned such that the hot streak impacts the pressure side and when it is determined that it would be more beneficial to have the benefits of a more uniform temperature manifest themselves at a first stage rotor then the first static turbine vane is positioned such that the hot streak will impact the suction side.

5. The gas turbine engine design process as set forth in claim 4, wherein the suction side is selected to impact the hot streak when the first stage rotor is a single stage rotor.

6. A gas turbine engine comprising:
a combustor having a plurality of combustor nozzles;
a first row of static turbine vanes positioned downstream of said combustor nozzles and a first turbine rotor stage positioned downstream of said first row of said static turbine vanes, said static turbine vanes including a pressure side and a suction side, and said combustor nozzles creating a hot streak within a flow of products of combustion approaching said first row of static turbine vanes with some of said first row of static turbine vanes being positioned such that said hot streak will impact one of said suction side and said pressure side.

7. The gas turbine engine as set forth in claim 6, wherein the location of the hot streak is determined by computer modeling.

8. The gas turbine engine as set forth in claim 7, wherein the computer modeling relies on computational fluid dynamics.

9. The gas turbine engine as set forth in claim 6, wherein the hot streak impacts the suction side and the first turbine rotor stage is a single stage rotor.
